(19) United States
(12) Patent Application Publication
(10) Pub. No.: US 2004/0145578 A1
(43) Pub. Date: Jul. 29, 2004

(54) Pen-type input apparatus

(76) Inventor: Chi-nan Wang, Taipei (TW)

Correspondence Address: BIRCH STEWART KOLASCH & BIRCH, PO BOX 747, FALLS CHURCH, VA, 22040-0747, US

(21) Appl. No.: 10/403,017

(22) Filed: Apr. 1, 2003

(30) Foreign Application Priority Data
Jan. 13, 2003 (TW) 92200557

(51) Int. Cl. G09G 5/00

(52) U.S. Cl. 345/179

(57) ABSTRACT

A pen-type input apparatus for inputting data into a processing device is provided. The pen-type input apparatus includes a micro-controller, a direction-sensing module, a first button, and a second button. The direction-sensing module is coupled to the micro-controller to provide a first direction data. The first button is coupled to the micro-controller to provide a first command. The second button is coupled to the micro-controller to provide a second command. The micro-controller is used to process the first direction data and output a second direction data.

### CROSS REFERENCE TO RELATED APPLICATIONS

This application claims priority of Taiwan patent application Ser. No. 092200537 filed on Jan. 13, 2003.

### BACKGROUND OF THE INVENTION

1. Field of Invention

The present invention relates to a pen-type input apparatus.

The mouse is one of common input apparatuses to computers. For the general operating systems or utility software, the mouse facilitates moving of cursor, selection of a range, dragging of an object, or displaying of a menu on the interface.

However, using the mouse involves the user's wrist pressing the mouse for a long period of time accumulatively. Therefore, illnesses, e.g. carpal tunnel syndrome, are often induced.

### SUMMARY OF THE INVENTION

One aspect of the invention provides a pen-type input apparatus, which has functions of the traditional mouse and is easy to use.

The main aspect of the pen-type input apparatus lies in the pen-type appearance and how the direction data is provided. A direction-sensing module similar to the traditional joystick provides the direction data in the invention.

A pen-type input apparatus for inputting data into a processing device is provided. The pen-type input apparatus includes a micro-controller, a direction-sensing module, a first button and a second button. The direction-sensing module is coupled to the micro-controller and provides a first direction data. The first button is coupled to the micro-controller and provides a first command. The second button is coupled to the micro-controller and provides a second command. The micro-controller processes the first direction data and provides the processing device with a second direction data. The first command may include a selection command, a drag command, a menu display command, a specific drag command, or other commands. The second command may include a selection command, a drag command, a menu display command, a specific drag command, or other commands.

The direction-sensing module mentioned above includes a direction-sensing circuit board, a conductive rubber disk, an operating stick and a cap. The direction-sensing circuit board is coupled to the micro-controller. When the conductive rubber disk is disposed horizontally, the conductive rubber disk has a center touching the direction-sensing circuit board. The operating stick has a first end and a second end, and the second end is vertically coupled to the conductive rubber disk. The cap is for covering the operating stick. When the first end of the operating stick receives a force and points to a direction, an area the conductive rubber disk touching on the direction-sensing circuit board in the direction increases to provide the first direction data. When the first end of the operating stick receives a force and points to a first direction, the second direction data indicates a second direction, and the second direction is opposite to the first direction.

The pen-type input apparatus further includes a wireless transmission module and a power module. The wireless transmission module is coupled to the micro-controller and outputs the second direction data, the first command, and the second command. The wireless transmission module may be a blue tooth module, an infrared transmission module, a radio frequency transmission module, or the like. The power module is coupled to the micro-controller and supplies power to the pen-type input apparatus.

The power module mentioned above includes a charging management module and a rechargeable battery. The charging management module is coupled to the micro-controller. The charging management module may be an inductive charging module, a wire-charging module, or the like. The rechargeable battery is coupled to the charging management module. Other than charging the rechargeable battery, the charging management module may monitor and control the power consumption status.

The pen-type input apparatus still further includes a roller coupled to the micro-controller to provide a third command. The third command may include a scroll command, or other commands.

### BRIEF DESCRIPTION OF THE DRAWINGS

For a more complete understanding of the present invention, and the advantage thereof, reference is now made to the following descriptions taken in conjunction with the accompanying drawings, in which:

FIG. 1 is a block diagram of an exemplary embodiment;

FIG. 2 is a schematic diagram showing the appearance of an exemplary direction-sensing module; and

FIG. 3 is a schematic diagram showing the appearance of an exemplary embodiment.

### DETAILED DESCRIPTION

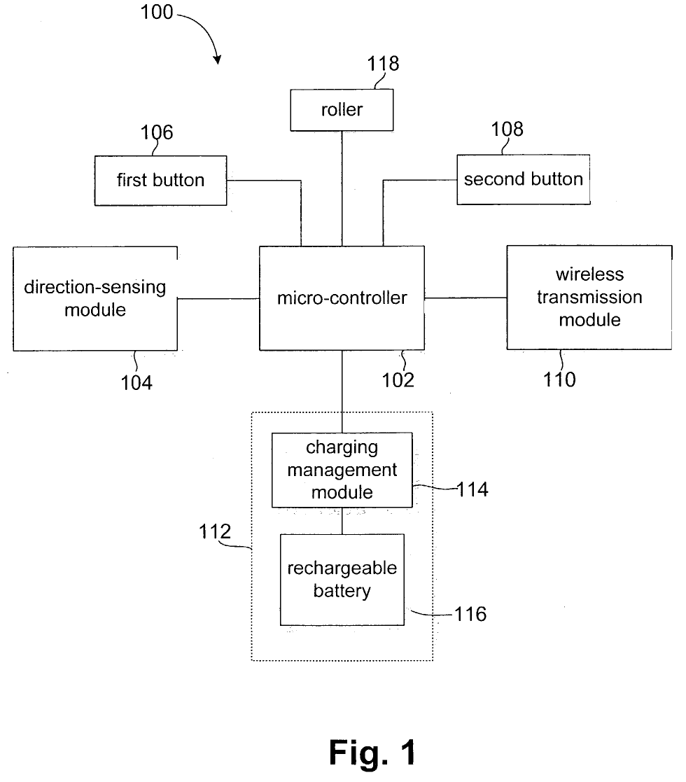

FIG. 1 is a block diagram of an exemplary embodiment 100. The exemplary embodiment 100 is for inputting data into a processing device. The exemplary embodiment 100 includes a micro-controller 102, a direction-sensing module 104, a first button 106 and a second button 108. The direction-sensing module 104 is coupled to the micro-controller 102 and provides a first direction data. The first button 106 is coupled to the micro-controller 102 and provides a first command. The second button 108 is coupled to the micro-controller 102 and provides a second command. The micro-controller 102 processes the first direction data and provides the processing device with a second direction data. The first command may include a selection command, a drag command, a menu display command, a specific drag command, or other commands. The second command may include a selection command, a drag command, a menu display command, a specific drag command, or other commands.

Still referring to FIG. 1, the exemplary embodiment 100 further includes a wireless transmission module 110 and a power module 112. The wireless transmission module 110 is coupled to the micro-controller 102 and outputs the second direction data, the first command, and the second command. The wireless transmission module 110 may be a blue tooth module, an infrared transmission module, a radio frequency transmission module, or the like. The power module 112 is coupled to the micro-controller 102 and supplies power to entire exemplary embodiment 100. The power module 112 includes a charging management module 114 and a rechargeable battery 116. The charging management module 114 is coupled to the micro-controller 102. The charging management module 114 may be an inductive charging module, a wire-charging module, or the like. The rechargeable battery 116 is coupled to the charging management module 114. Other than charging the rechargeable battery, the charging management module 114 may monitor and control the power consumption status.

With continued reference to FIG. 1, the exemplary embodiment 100 further includes a roller 118 coupled to the micro-controller 102, to provide a third command. The third command may include a scroll command, or other commands.

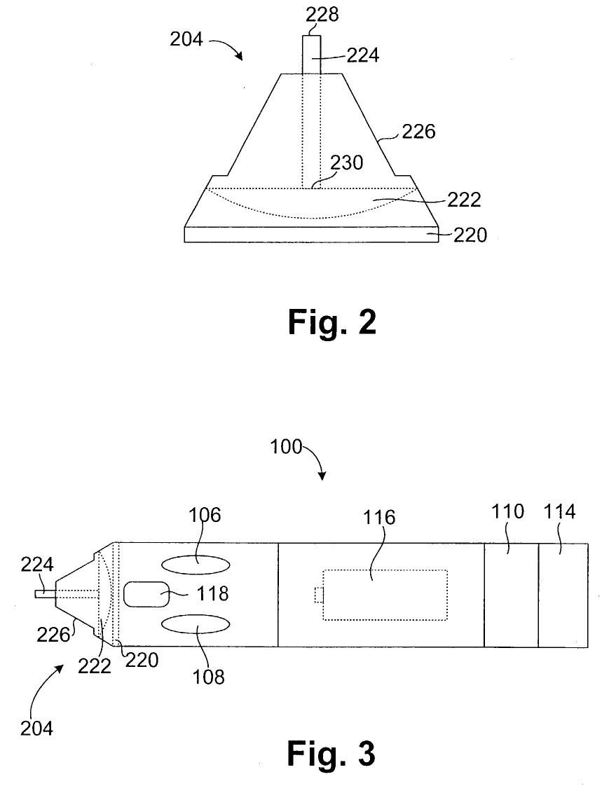

FIG. 2 is a schematic diagram showing the appearance of an exemplary direction-sensing module 204. The direction-sensing module 204 includes a direction-sensing circuit board 220, a conductive rubber disk 222, an operating stick 224 and a cap 226. The direction-sensing circuit board 220 is coupled to the micro-controller (not shown). When the conductive rubber disk 222 is disposed horizontally, the conductive rubber disk 222 has a center touching the direction-sensing circuit board 220. The operating stick 224 has a first end 228 and a second end 230, and the second end 230 is vertically coupled to the conductive rubber disk 222. The cap 226 is for covering the operating stick 224. When the first end 228 of the operating stick 224 receives a force and points to a direction, an area the conductive rubber disk 222 touching on the direction-sensing circuit board 220 in the direction increases to provide the first direction data. When the first end 228 of the operating stick 224 receives a force and points to a first direction, the second direction data indicates a second direction, and the second direction is opposite to the first direction.

Referring to FIG. 3, the appearance of the exemplary embodiment 100 is pen-type. Therefore it is easier to use than conventional mouse. Besides, the direction-sensing module 204 similar to the joystick provides the direction data.

While this invention has been described with reference to the illustrative embodiment, these descriptions are not is intended to be construed in a limiting sense.

Various modifications of the illustrative embodiments, as well as other embodiments of the invention, will be apparent upon reference to these descriptions. It is therefore contemplated that the appended claims will cover any such modifications or embodiments as falling within the true scope of the invention and its legal equivalents.

1. A pen-type input apparatus for inputting data into a processing device, comprising:
a micro-controller;
a direction-sensing module, coupled to said micro-controller, for providing a first direction data;
a first button, coupled to said micro-controller, for providing a first command; and
a second button, coupled to said micro-controller, for providing a second command;
wherein said micro-controller processes said first direction data and provides said processing device with a second direction data.

2. The pen-type input apparatus of claim 1, wherein said direction-sensing module comprising:
a direction-sensing circuit board coupled to said micro-controller;
a conductive rubber disk having a center touching said direction-sensing circuit board as said conductive rubber disk is disposed horizontally;
an operating stick having a first end and a second end, and said second end being vertically coupled to said conductive rubber disk; and
a cap for covering said operating stick;
wherein as said first end of said operating stick receives a force and points to a direction, an area said conductive rubber disk touching on said direction-sensing circuit board in said direction increases, for providing said first direction data.

3. The pen-type input apparatus of claim 2, further comprising:
a wireless transmission module, coupled to said micro-controller, for outputting said second direction data, said first command, and said second command; and
a power module, coupled to said micro-controller, for supplying power to said pen-type input apparatus.

4. The pen-type input apparatus of claim 3, wherein said power module comprising:
a charging management module coupled to said micro-controller; and
a rechargeable battery coupled to said charging management module.

5. The pen-type input apparatus of claim 3, further comprising a roller coupled to said micro-controller for providing a third command.

6. The pen-type input apparatus of claim 3, wherein said wireless transmission module is a blue tooth module.

7. The pen-type input apparatus of claim 3, wherein said wireless transmission module is an infrared transmission module.

8. The pen-type input apparatus of claim 3, wherein said wireless transmission module is a radio frequency transmission module.

9. The pen-type input apparatus of claim 4, wherein said charging management module comprising an inductive charging module.

10. The pen-type input apparatus of claim 4, wherein said charging management module comprising a wire-charging module.

11. The pen-type input apparatus of claims 2 to 10, wherein as said first end of said operating stick receives a force and points to a first direction, said second direction data indicates a second direction, and said second direction is opposite to said first direction.

12. The pen-type input apparatus of claims 1 to 10, wherein said first command includes a selection command, a drag command, a menu display command, or a specific drag command.

13. The pen-type input apparatus of claims 1 to 10, wherein said second command includes a selection command, a drag command, a menu display command, or a specific drag command.

14. The pen-type input apparatus of claim 5, wherein said third command includes a scroll command.
